(19) United States
(12) Patent Application Publication
(10) Pub. No.: US 2007/0295128 A1
(43) Pub. Date: Dec. 27, 2007

(54) Lead screw actuator with torsional anti-backlash nut

(76) Inventors: Keith W. Erikson, Hollis, NH (US); Kenneth W. Erikson, Amherst, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/437,431

(22) Filed: May 19, 2006

(51) Int. Cl. F16H 27/02; F16H 29/02

(52) U.S. Cl. 74/89.42

(57) ABSTRACT

A linear actuator assembly, such as a rod or piston-type linear actuator, comprising a rotating lead screw with external threads; and a nut assembly with threads engageable with the external threads of the lead screw; and a guide tube having a hollow interior portion with at least one internal surface. The lead screw and nut assembly are located within the hollow interior portion of the lead screw, and the guide tube is configured to prevent the nut assembly from rotating with the lead screw. The nut assembly translates in a linear direction within the guide tube as the lead screw rotates. A portion of the nut assembly, such as a wedge, is radially biased against an internal surface of the guide tube. In one aspect, an axial compression spring is pre-loaded against the wedge and pushes the wedge up a ramp surface on the nut, and into the internal surface of the guide tube. The radially-biased wedge helps minimize torsional backlash in the assembly. The assembly can include a piston or rod that is attached to the nut assembly, and reciprocates into and out of the guide tube in a telescoping fashion. The nut assembly can also include an anti-backlash nut having a plurality of internally-threaded longitudinal flexure members. The axial compression spring that is pre-loaded against the wedge also drives the threads of the flexure members into the threads of the lead screw to minimize axial backlash.

### BACKGROUND OF THE INVENTION

Devices and methods for bilateral motion of a load are known which utilize a rotating lead screw and a threaded nut that is driven by the lead screw. Generally in these devices, the nut is a non-rotatable member that is attached to a load or other machine element. The nut is driven linearly, in both forward and reverse directions, by the rotation of the lead screw on which it is threaded.

Examples of lead screw and nut linear actuator systems are found in, for example, U.S. Pat. Nos. 6,422,101, 5,913,940, 4,974,464, and Re. 32,433, and U.S. Published Application 2005/0178225 A1, the entire teachings of which are incorporated herein by reference. These references disclose various lead screw actuator systems having very accurate linear reciprocation of a nut.

It would be desirable to have a rod or piston-type linear actuator having a high degree of positional accuracy and minimal backlash or “play” in the actuator system.

### SUMMARY

In one aspect, the present invention is directed to a linear actuator, including a rod or piston-type linear actuator, that comprises a lead screw having external threads and rotatable about an axis; a nut assembly comprising a nut having threads engageable with the external threads of the lead screw; and a guide tube having a hollow interior portion with at least one internal surface. The lead screw and nut assembly are disposed within the hollow interior portion of the lead screw, and the guide tube is configured to prevent the nut assembly from rotating when the lead screw rotates. The nut assembly translates in a linear direction within the guide tube as the lead screw rotates. A portion of the nut assembly is radially biased against an internal surface of the guide tube to minimize torsional backlash in the actuator assembly.

In a preferred embodiment, the assembly includes a rod that is attached to the nut assembly, and translates in a linear direction relative to guide tube. The rod can include internal threads that engage with external threads on the nut. The rod can include a hollow interior portion so that the rod can reciprocate over a portion of the lead screw. Preferably, the reciprocating rod is able to extend out from the guide tube, and retract into guide tube, in a telescoping fashion.

According to one aspect of the invention, the nut assembly comprises a nut having a ramp with an angled surface, and a wedge having a flat top surface and an angled bottom surface. The nut assembly further comprises a spring means, such as an axial compression spring, that is pre-loaded against the wedge, and pushes the wedge up the ramp to radially bias the flat upper surface of the wedge against the interior surface of the guide tube and minimize torsional backlash in the actuator assembly. Preferably, the nut assembly comprises a plurality of ramps and wedges around the circumference of the nut assembly, and one or more axial compression springs is pre-loaded against the wedges.

In yet another aspect, the nut assembly comprises an anti-backlash nut including a plurality of longitudinal flexure members, each including internal threads for engaging with the threads of the lead screw. A spring means, such as an axial compression spring, is pre-loaded against a collar extending around the circumference of the longitudinal flexure members, and pushes the collar against the longitudinal flexure members to radially bias the threads of the longitudinal flexure members against the threads of the lead screw and minimize axial backlash of the nut assembly. In a preferred embodiment, the axial compression spring is also pre-loaded against a wedge to radially bias the wedge against the interior surface of the guide tube to minimize torsional backlash in the actuator assembly.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a side view of a lead screw actuator in accordance with one aspect of the invention;

FIG. 2 is a cross-sectional side view of the lead screw actuator of FIG. 1;

FIG. 3 is a perspective view of an anti-backlash nut according to one aspect of the invention;

FIG. 4 is a cross-sectional view of a lead screw actuator with a nut and guide tube;

FIGS. 5A-5C show a torsional anti-backlash nut with a ramp and a wedge for wear compensation.

### DETAILED DESCRIPTION

A description of preferred embodiments of the invention follows.

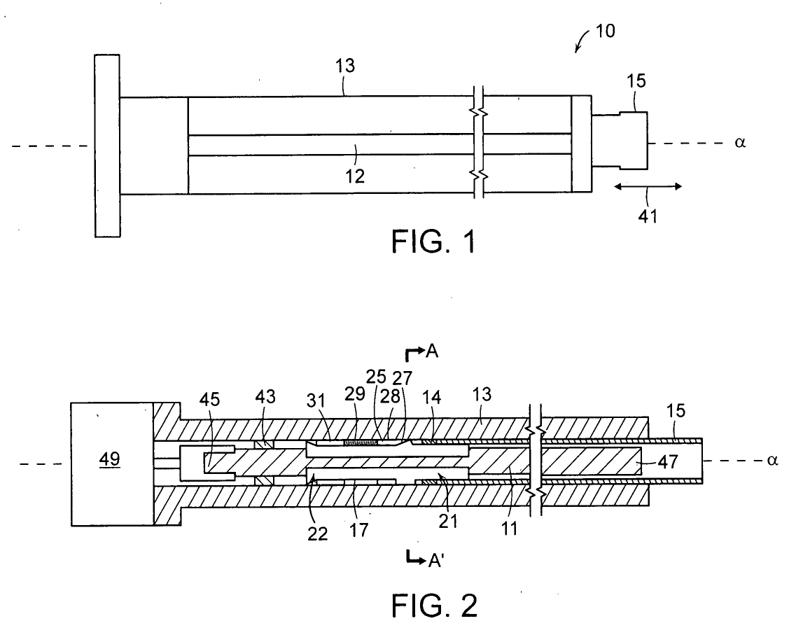

FIGS. 1 and 2 illustrate a lead screw actuator assembly 10 in accordance with one embodiment of the invention. FIG. 1 is a side exterior view of the actuator assembly 10 and FIG. 2 shows the interior components of the assembly 10. The actuator assembly 10 includes an exterior guide tube 13, and a piston or rod 15 that is housed in the guide tube 13, and reciprocates in the direction of arrow 41 relative to the guide tube 13. In operation, the guide tube 13 is generally fixed in a stationary position, and the rod 15 bilaterally translates relative to the guide tube 13. The rod 15 can be connected to a load, and the assembly can be used to drive the load to a predetermined position along a linear path, defined by axis, α. The guide tube 13 can include one or more axial grooves or slots 12 for mounting sensors to determine the position of the rod 15 relative to the guide tube 13.

FIG. 2 shows the internal components of the actuator 10. As shown in FIG. 2, the actuator 10 includes a lead screw 11 housed within the guide tube 13. The lead screw is secured within the guide tube 13 by bearings 43 that permit the lead screw 11 to rotate within the guide tube 13 about axis α. The lead screw 11 has a first end 45 that is coupled to a drive mechanism 49, such as a motor, for rotating the lead screw 11 in clockwise and counterclockwise directions about axis α. As shown in FIG. 2, the rod 15 includes a hollow interior, and a second, free end 47 of the lead screw 11 is adapted to fit within the hollow interior of the rod 15.

As shown in FIG. 2, a magnet 14 can be provided at the base of the rod 15, and can be used in conjunction with the sensors in the slots 12 of the guide tube 13 to determine the position of the rod 15 relative to the guide tube.

The lead screw 11 has a threaded outer surface. A nut 17 having one or more internally threaded surfaces is threaded over the lead screw 11. In the embodiment shown in FIG. 2, the nut 17 has a first portion 21 and a second portion 22. The first portion 21 of the nut 17 is attached to the rod 15 using any suitable means. In one embodiment, the first portion 21 of the nut 17 includes external threads, and the rod 15 includes internal threads that are threaded over the first portion 21 of the nut 17 to secure the rod 15 to the nut 17. In operation, the rotation of the lead screw 17 relative to the nut 17 to which it is threadingly engaged causes the nut 17 to translate along axis α. The nut 17 is connected to rod 15, and the translation of the nut 17 relative to the lead screw 11 therefore drives the rod 15 in a linear direction relative to the guide tube 13. As is described in further detail below, the guide tube 13 includes a mechanism for preventing the nut 17 from rotating with the rotation of the lead screw 11. Because the nut 17 is constrained from rotating with the lead screw, the rotation of the lead screw 11 causes the nut 17 to translate along the length of the lead screw 11.

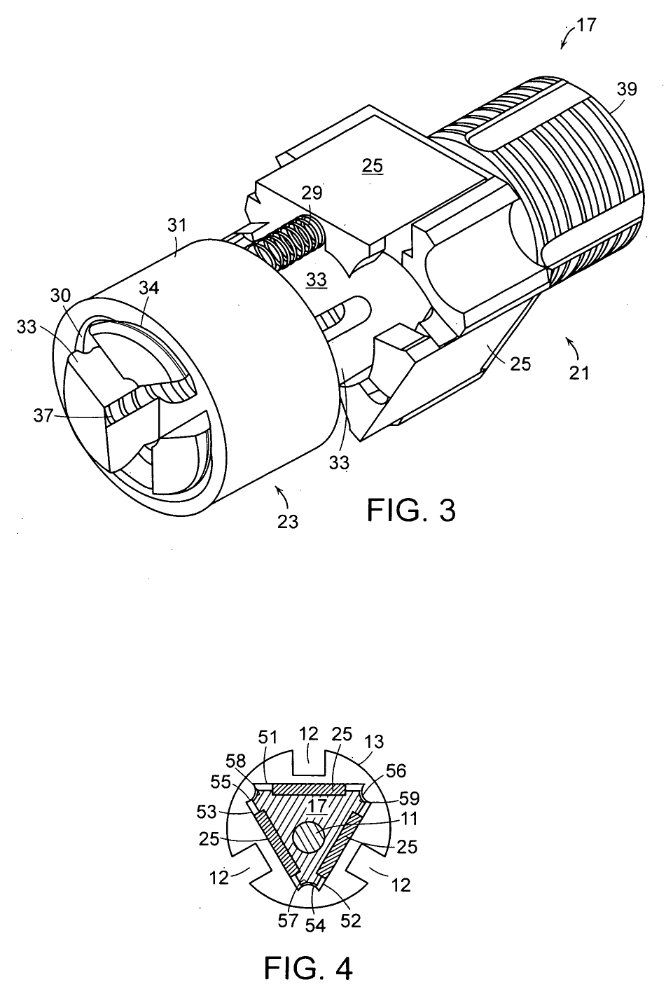

As shown in FIGS. 2 and 3, the nut 17 can include one or more compression springs 29 extending between the first portion 21 and the second portion 22 of the nut 17. The first portion 21 of the nut 17 can include one or more angled surfaces or ramps 27. One or more wedges 25 can be disposed on the ramps 27. Each wedge 25 comprises a flat upper surface 28, and an angled lower surface 30 that is designed to mate with ramp 27. One end of each compression spring 29 abuts the second portion 22 of the nut 17, and the other end of the spring 29 abuts the rear wall of a wedge 25. The spring 29 is biased in an axial direction, and pushes the wedge 25 into and up the angled surface of ramp 27. The flat upper surface 28 of the wedge 25 is thus biased radially outwards from the nut 17 and lead screw 11, and into the interior surface of guide tube 13.

The ramp 27 on the nut 17 can comprise a pad made from a smooth material, such as neoprene, and the wedge 25 can be made from a self-lubricating plastic.

FIG. 4 shows a cross-sectional view of the assembly along line A-A′ in FIG. 2. As is evident from FIG. 4, the interior of guide tube 13 is designed to receive nut 17, and prevent the nut 17 from rotating relative to the tube 13. In the embodiment shown in FIG. 4, the guide tube 13 includes three flat surfaces, 51, 52 and 53, separated by rounded protrusions, 54, 55, 56, that extend along the length of the guide tube 13. The nut 17 includes slots 57, 58 and 59 that mate with the rounded protrusions 54, 55, 56 on the guide tube 13. In addition, the nut includes three wedges 25 that are biased against the three flat surfaces 51, 52, 53 of the guide tube 13. As is clear from FIG. 4, the geometries of the guide tube 13 and nut 17 are such that the nut 17 is not permitted to rotate relative to the guide tube 13, even when the lead screw 11 to which it is engaged is rotating. Furthermore, the nut 17 is able to translate in an axial direction (i.e. into and out of the page in FIG. 4) along the length of the guide tube 13. Moreover, in the embodiment shown in FIG. 4, the three wedges 25 are biased radially outward from the nut 17, and into the flat surfaces 51, 52, 53 of the tube. This advantageously minimizes torsional backlash in the actuator system. Because the wedges 25 are biased against the interior surface of the guide tube 13, there is little rotational “play” between the stationary guide tube and the nut/rod assembly that translates within the tube. This improves the positional accuracy of the actuator system.

The amount of this torsional backlash control is determined by the bias force of the compression spring(s) 29 that push against the wedge(s) 25. Using a lower bias force in the spring(s) will allow for more torsional “play” in the actuator. A higher bias force in the spring(s) will minimize or eliminate torsional “play” entirely, though a higher bias force in the spring(s) will also increase the frictional force between the wedge(s) and the interior surface of the guide tube. The user can adjust the torsional backlash control by selecting spring(s) with the appropriate bias force for the particular application of the actuator system.

FIG. 4 illustrates one example of a guide tube and nut configuration, and it will be understood that various alternative designs could be employed. What is significant is that the guide tube includes a mechanism that prevents the nut from rotating relative to the guide tube, while permitting the nut to translate in an axial direction within the tube. In certain embodiments, the nut can include a mechanism that is biased radially outward, against the interior of the guide tube, to minimize torsional backlash within the actuator system.

In certain embodiments of the invention, the nut 17 can be an anti-backlash nut that minimizes the axial “play” between the threads of the nut 17 and the mating threads of the lead screw 11. Examples of this type of anti-backlash nut are described in commonly-owned U.S. Pat. Nos. 5,913,940 and Re. 32,433, the entire teachings of which are incorporated herein by reference. One embodiment of an anti-backlash nut 17 of the present invention is shown in FIG. 3. The nut 17 includes a first portion 21, including external threads 39 for connecting a reciprocating piston or rod to the nut. The first portion 21 also includes a hollow interior with internal threads for engaging with the threads of a lead screw. A plurality of wedges 25 are in contact with the first portion 21 of the nut 17, and surround the periphery of the nut 17. In this embodiment, there are three wedges 25, although only two are visible in FIG. 3.

The second portion 23 of the nut 17 includes a plurality of longitudinal flexure members 33. One end of each flexure member 33 is fixed to the nut, and a second end is free-floating. Each of the longitudinal flexure members 33 includes internal threads 37 for engaging with the threads of a lead screw. Preferably, the free-floating ends of the longitudinal flexure members 33 each include an angled surface or ramp 34, and a ring or collar 31 surrounding all of the members 33 and abutting each ramp 34. In certain embodiments, an o-ring 30 can be provided between the collar 31 and each ramp 34. One or more compression springs 29 are positioned between, and pre-loaded against, the wedges 25 and the collar 31. The function of the compression springs 29 are two-fold in this embodiment. First, as previously discussed, the springs 29 produce the bias force against the wedges 25 that push the wedges against the interior of the guide tube 13, thereby minimizing torsional backlash in the actuator system. Second, the compression springs 29 provide a bias force against the collar 31 that pushes each of the longitudinal flexure members 33 radially inward, and thus pushes the threads 37 of the flexure members 37 tight against the mating threads of the lead screw. This minimizes the axial “play” between the threads of the lead screw and the threads of the nut. The design of the nut in this embodiment also compensates for wear on the threads of the nut, since as the threads on the nut become worn, the compression springs 29 push the collar 31 further up the ramps 34 on the flexure members 33, thereby maintaining a radial force vector that ensures good contact between the threads of the flexure members and the threads of the lead screw.

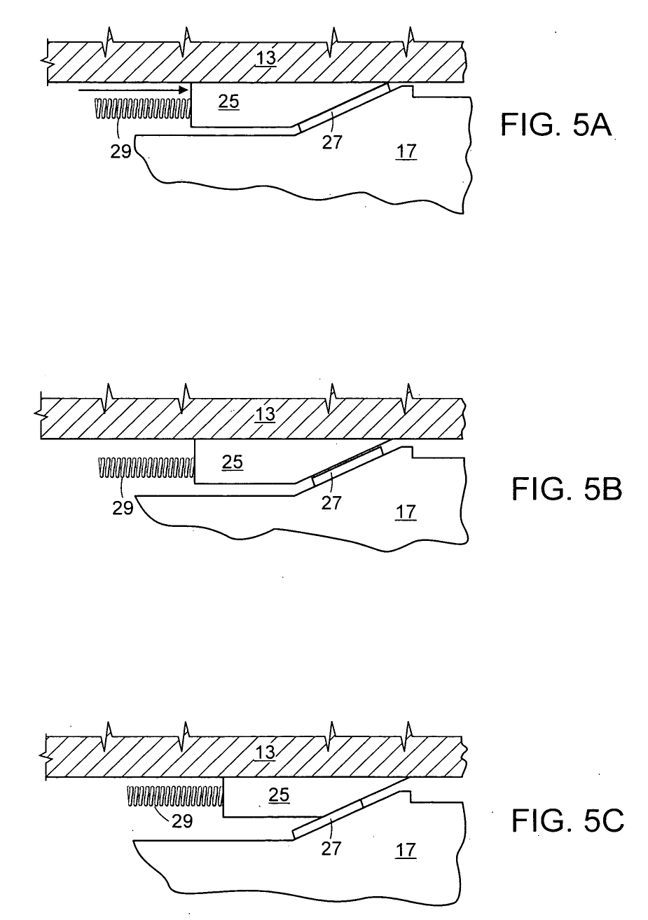

Turning now to FIGS. 5A-5C, a wear-compensation function of the present actuator system with torsional anti-backlash nut is demonstrated. Wear-compensation may be desirable for applications in which the nut 17 will have an extended length-of-service. As the nut 17 reciprocates within the guide tube 13 over a prolonged period of time, the flat upper surface 28 of wedge 25 will eventually begin to wear away. If this wear is not compensated for, then the torsional backlash of the actuator system can increase over time. According to one aspect of the invention, the nut 17 is designed to compensate for this wear over time, and maintain a high degree of backlash control. FIG. 5A is a cross-sectional view of a nut 17 having a ramp 27 with an angled surface, a wedge 25 having an angled lower surface 30 that abuts the angled surface of the ramp 27, and a compression spring 29 that pre-loads the wedge 27 against the ramp 27. The entire nut 17 is threaded on a lead screw 11, and is housed within a guide tube 13. As previously discussed, the wedge 25 is pushed by the spring 29 up the angled surface of the ramp 27, so that the flat upper surface 28 of the wedge 25 contacts an interior surface 51 of the guide tube 13. FIG. 5A illustrates the initial condition of the nut 17 and wedge 25, prior to use. FIG. 5B shows the nut 17 and wedge 25 after a first period of extended use. As is clear from this figure, the upper surface 28 of the wedge 25 has partially worn away due to friction with the interior surface 51 of the guide tube 13. However, as the wedge 25 wears away and becomes smaller, the spring 29 continues to push the wedge 25 up the ramp to maintain an outward radial bias against the interior surface 51 of the guide tube 13. FIG. 5C shows the nut 17 after a further period of extended use. Here again, even though the wedge 25 has substantially worn away as compared to its initial condition, the spring 29 continues to advance the wedge 25 up the ramp 27 to maintain the outward radial bias against the guide tube 13. Thus, even after extended use and wear, the nut 17 of the present invention is able to maintain a predetermined level of torsional backlash control.

While this invention has been particularly shown and described with references to preferred embodiments thereof, it will be understood by those skilled in the art that various changes in form and details may be made therein without departing from the scope of the invention encompassed by the appended claims. For example, the nut and guide tube can be configured to use more or less than three wedges and mating interior surfaces on the guide tube.

What is claimed is:

1. A linear actuator assembly, comprising:
a lead screw having external threads and rotatable about an axis;
a nut assembly comprising a nut having threads engageable with the external threads of the lead screw; and
a guide tube having a hollow interior portion with at least one internal surface, the lead screw and nut assembly being disposed within the hollow interior portion of the lead screw, the guide tube configured to prevent the nut assembly from rotating when the lead screw is rotatable about an axis, the nut assembly translating in a linear direction within the guide tube as the lead screw rotates, a portion of the nut assembly being radially biased against the at least one internal surface of the guide tube to minimize torsional backlash of the actuator assembly.

2. The assembly of claim 1, further comprising:
a rod attached to the nut assembly, the rod translating in a linear direction with the movement of the nut assembly.

3. The assembly of claim 2, wherein the rod reciprocates in two linear directions.

4. The assembly of claim 2, wherein the rod is attached to the nut assembly by internal threads that engage with external threads on the nut.

5. The assembly of claim 3, wherein the rod comprises a hollow interior portion that permits the rod to reciprocate over at least a portion of the lead screw.

6. The assembly of claim 3, wherein the reciprocating rod extends out from the guide tube, and retracts into the guide tube, in a telescoping fashion.

7. The assembly of claim 1, wherein the nut assembly comprises:
a nut comprising a ramp with an angled surface; and
a wedge comprising a flat top surface and an angled bottom surface, the wedge contacting the ramp.

8. The assembly of claim 7, further comprising a spring means pre-loaded against the wedge to push the angled bottom surface of the wedge against the ramp.

9. The assembly of claim 8, wherein the spring means comprises an axial compression spring.

10. The assembly of claim 9, wherein the spring pushes the wedge up the ramp to radially bias the flat upper surface of the wedge against the at least one interior surface of the guide tube.

11. The assembly of claim 7, wherein the nut assembly comprises a plurality of ramps and wedges around the circumference of the nut assembly.

12. The assembly of claim 11, further comprising one or more spring means that push the plurality of wedges up the plurality of wedges to radially bias the flat upper surfaces of the wedges against the interior surface of the guide tube.

13. The assembly of claim 12, wherein the spring means comprises an axial compression spring around the nut.

14. The assembly of claim 13, wherein the spring means comprises a plurality of axial compression springs, each spring contacting a different wedge.

15. The assembly of claim 11, wherein the plurality of wedges and ramps are equally spaced around the circumference of the nut assembly.

16. The assembly of claim 1, wherein the nut assembly comprises an anti-backlash nut, comprising:
a plurality of longitudinal flexure members, each of said members including internal threads for engaging with the threads of the lead screw;
a collar extending around the circumference of the longitudinal flexure members; and
spring means pre-loaded against the collar to push the collar against the longitudinal flexure members and radially bias the threads of the longitudinal flexure members against the threads of the lead screw and minimize axial backlash of the nut assembly.

17. The assembly of claim 16, wherein the spring means comprises an axial compression spring.

18. The assembly of claim 16, wherein the longitudinal flexure members have ramp surfaces, the collar being pushed against the ramp surfaces to radially bias the threads of the longitudinal flexure members against the threads of the lead screw.

19. The assembly of claim 17, wherein the spring means is additionally pre-loaded against a wedge.

20. The assembly of claim 19, wherein the spring means pushes the wedge up a ramp surface on the nut to radially bias a flat upper surface of the wedge against the interior surface of the guide tube and minimize torsional backlash in the actuator assembly.

21. The assembly of claim 20, wherein the spring means is pre-loaded against a plurality of wedges contacting a plurality of ramp surfaces around the circumference of the nut assembly.

22. The assembly of claim 20, wherein the spring means comprises an axial compression spring.
